(19) United States
(12) Patent Application Publication
(10) Pub. No.: US 2018/0216688 A1
(43) Pub. Date: Aug. 2, 2018

(54) ELASTIC SUPPORT

(71) Applicant: SUEDDEUTSCHE GELENKSCHEIBENFABRIK GMBH & CO. KG, Waldkraiburg (DE)

(72) Inventor: Klaus Steinmaier, Kraiburg am Inn (DE)

(21) Appl. No.: 15/884,180

(22) Filed: Jan. 30, 2018

(30) Foreign Application Priority Data
Jan. 30, 2017 (DE) 10 2017 000 829.9

(51) Int. Cl. F16F 3/093; F16F 15/04; F01N 13/18

(52) U.S. Cl. CPC F16F 3/093; F16F 15/046; F16F 3/12; F16F 2236/123; F01N 13/1811

(57) ABSTRACT

The present invention relates to an elastic support for a load, with at least one elastomer body; the at least one elastomer body has at least one spring section and at least two receiving openings for receiving fastening elements; the spring section has at least one reinforcement; at least one of the two receiving openings is positioned outside of the reinforcement of the at least one spring section; and at least one of the two receiving openings is associated with at least one reinforcement that surrounds the respective receiving opening and is connected to the reinforcement of the spring section.

The present invention relates to an elastic support for a load. The elastic support can in particular be used for mounting an exhaust system to the body of a vehicle.

DE 198 12 347 C1 discloses a suspension eye with an annular elastomer body. The elastomer body is delimited by an outer wall and an inner wall and has two diametrically opposed suspension poles and two equatorial zones. A flexible insert is embedded in the elastomer body in order to transmit tensile loads from one suspension pole to the other suspension pole.

DE 199 06 548 C1 discloses an elastic support, which is used for suspending a dynamically loaded functional part such as an exhaust system of a motor vehicle. The elastic support has a loop composed of a molded body made of bent spring steel whose ends are permanently connected to each other and two support sleeves that are positioned in the loop and are supported on the spring steel molded body, one for a supporting fastening element and one for a supported fastening element. In two regions spaced apart from each other, a damper arm composed of an elastomer material engages with the spring steel belt section; the distance between these regions changes when relative movements occur between the supporting fastening element and the supported fastening element.

One object of the present invention is to provide an elastic support that requires less installation space and has an extended service life.

The elastic support according to the invention includes at least one elastomer body; the at least one elastomer body has at least one spring section and at least two receiving openings for receiving fastening elements; the spring section has at least one reinforcement; at least one of the two receiving openings is positioned outside of the reinforcement of the at least one spring section; and at least one of the two receiving openings is associated with at least one reinforcement that surrounds the respective receiving opening and is connected to the reinforcement of the spring section.

In the elastic support according to the invention, because of the reinforcement used, the elastomer of the elastomer body is acted on almost exclusively with compressive and/or shearing forces. The positioning of the receiving openings outside of the spring section further improves the function of the elastic support as a whole. The fact that the at least one receiving opening and the reinforcement associated with it are positioned outside of the spring section enables an improved distribution of the stresses in the spring section, i.e. no regions in which stress peaks occur are produced in the spring section. In addition, the fact that the receiving openings are positioned outside of the spring section enables a space-saving design of the elastic support. In particular, it is possible to embody the spring section with a smaller width in the horizontal direction. The increased distance between the receiving openings reduces up and down movements of the supported element, for example a vehicle exhaust system that it supports. Such movement particularly occurs if the supported element executes an oscillating motion around one of the receiving bores, for example when an exhaust system forces such an oscillating motion to occur due to thermal expansion.

The at least two receiving openings can be positioned outside of the reinforcement of the at least one spring section. Each of the two receiving openings can be associated with at least one reinforcement that surrounds the respective receiving opening and is connected to the reinforcement of the spring section.

The at least one spring section can be positioned between the at least two receiving openings. The center axes of the at least two receiving openings can lie on an imaginary line. The two receiving openings are positioned along this line, outside of the spring section. If several receiving openings are provided, then these receiving openings likewise lie on an imaginary line. Several receiving openings, however, can also lie on several imaginary lines that can, for example, extend at an angle relative to one another. If the elastomer body has several receiving openings, then these receiving openings can all be positioned outside of the at least one spring section.

The spring section can be composed of bending beams. The reinforcement of the spring section can extend along the bending beams. The reinforcement of the at least one spring section can have a self-contained form. The reinforcement of the spring section can, for example, be embodied as essentially annular or essentially rhomboid. The reinforcement can thus extend in a rhomboid fashion along the bending beams in the spring section. The elastomer of the elastomer body in the spring section is subjected to compressive and/or shearing force by the reinforcement when the distance between the receiving openings increases in the loaded state of the elastic support. The elastomer material sections positioned inside the reinforcement of the at least one spring section are subjected almost exclusively to compressive and/or shearing force. The bending beams can form bending beam pairs, which extend toward each other. The bending beams of the two bending beam pairs can be respectively connected to each other by means of a bent section. The bending beams can taper in the direction of the bent section. The two bent sections can each form a corner region of the rhomboid reinforcement in the spring section.

The reinforcements associated with the at least two receiving openings can be connected to the reinforcement of the at least one spring section at two transition points. The reinforcement of the spring section can extend between the transition points, along the bending beams and the bent sections. The transition points lie in a transition region of the elastomer body between the spring section and the respective receiving opening. Each bending beam pair can extend starting from one of the transition points or one of the transition regions. The bending beam pairs extend toward each other starting from the respective transition region, their distance from the transition region increasing continuously until the respective bent section.

The spring section can have at least one opening. The reinforcement of the spring section can surround or encompass the opening. The opening can be embodied between the bending beams and the bent sections of the spring section in the elastomer body. The opening can have at least one buffer element. The at least one buffer element can be embodied on the inner wall of the opening or be composed of a section of the inner wall of the opening. The opening can have several buffer elements, which are positioned opposite from one another. The buffer elements can limit a movement of the receiving openings toward one another. The buffer elements can prevent an overloading in the spring section.

The elastomer body can have at least two spring sections. The two spring sections can be positioned between at least two receiving openings. The spring sections can be connected by means of a transition region provided between them. The reinforcements of the two spring sections can be connected to each other. Another receiving opening can be embodied between the two spring sections. The additional receiving opening can be associated with a reinforcement. The reinforcement associated with the additional receiving opening can be connected to the reinforcements of the two spring sections. The remaining receiving openings can be positioned so that they are offset by a predetermined angle around the center axis of the receiving opening between the spring sections. The receiving opening between the spring bodies constitutes a receiving opening that is jointly associated with the two spring sections. In the case of an angled form of the elastomer body with two or more spring sections, the elastic support constitutes a fixed support. A support of this kind can absorb forces from three spatial directions. Such a support can be used, for example, to support the exhaust system in a vehicle. In this case, in addition to the forces in the direction of the vertical axis of the vehicle and in the transverse direction of the vehicle, this support can also absorb forces in the longitudinal direction of the vehicle.

The reinforcement of the at least one spring section and the reinforcement of the at least one receiving opening is a textile reinforcement. For example, strands and belts can be used for the textile reinforcements. The reinforcement of the spring section and the reinforcement of the at least one receiving opening, however, can also be a wire reinforcement, which is composed of one or more wires. The reinforcement of the at least one spring section and the reinforcement of the at least one receiving opening can be sewn to each other or woven with each other. The reinforcement of the at least one spring section and the reinforcement of the at least one receiving opening can be produced in one piece out of a single strand. In this case, the strand can be routed crosswise at the transition points between the spring section and the receiving opening.

The present invention also relates to an exhaust system for a vehicle equipped with an elastic support of the above-described type.

The present invention also relates to a vehicle equipped with an exhaust system of the above-described type.

Exemplary embodiments of the present invention will be described below in conjunction with the accompanying drawings. In the drawings:

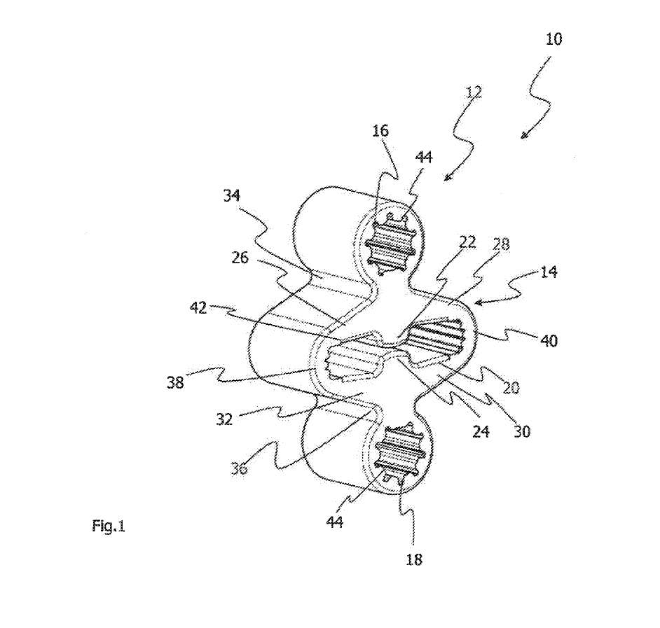

FIGS. 1 to 3 show an elastic support according to a first embodiment of the invention;

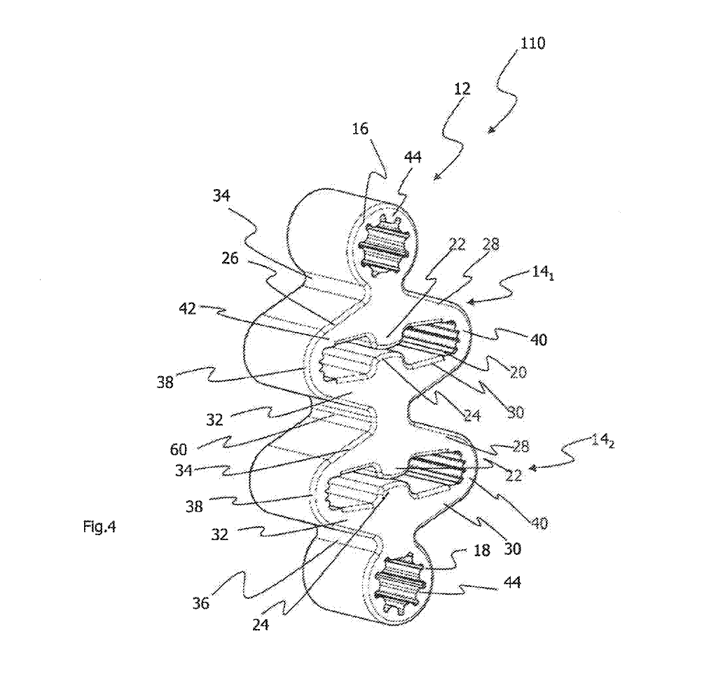

FIGS. 4 to 6 show an elastic support according to a second embodiment of the invention;

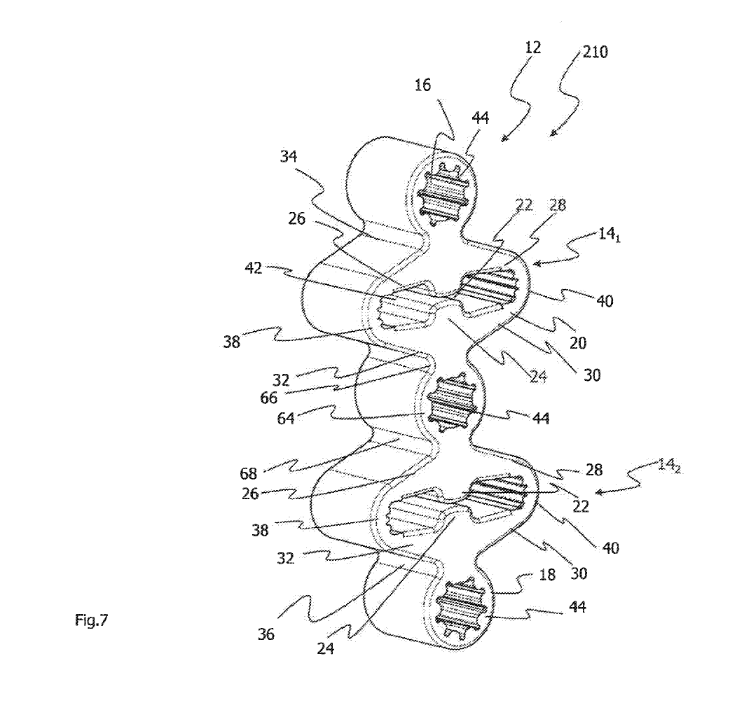

FIGS. 7 to 9 show an elastic support according to a third embodiment of the invention; and

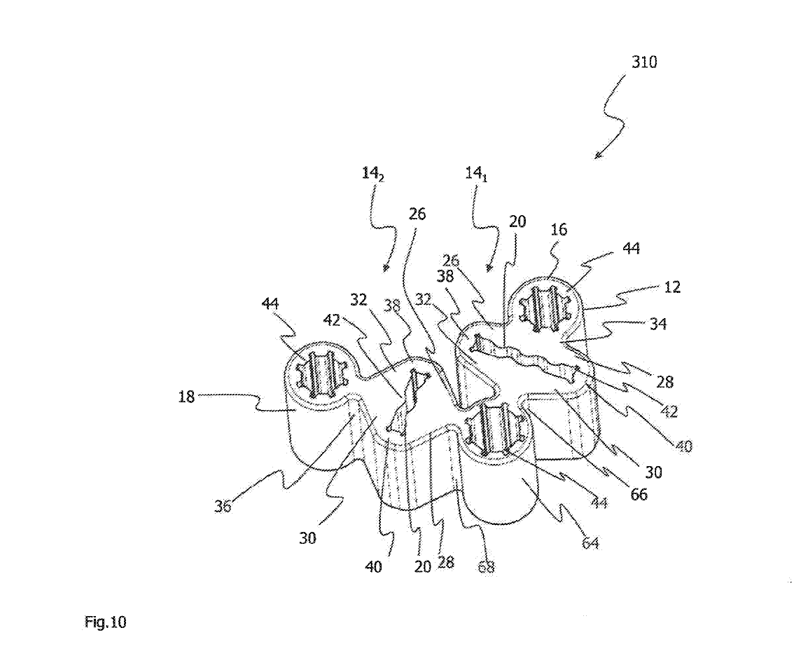

FIGS. 10 to 12 show an elastic support according to a fourth embodiment of the invention.

FIG. 1 shows a perspective view of an elastic support according to one embodiment of the invention in which the elastic support is generally identified with the reference numeral 10.

The elastic support 10 has an elastomer body 12. The elastomer body 12 includes a spring section 14 and two receiving openings 16 and 18. The receiving openings 16 and 18 are provided for receiving fastening elements. The fastening elements can, for example, be fastening bolts on the body of a vehicle and on the exhaust system of a vehicle. The receiving openings 16 and 18 are positioned outside of the spring section 14. The center axes M₁₆ and M₁₈ of the receiving openings 16 and 18 lie on a line G. The receiving openings 16, 18 are positioned on the line G, outside of the spring section 14. The line G corresponds to the symmetry axis of the elastic support 10, which is embodied as axially symmetrical.

The elastic support 10 has an opening 20 in the region of the spring section 14. Buffer elements 22 and 24 are provided in the opening 20. The buffer elements 22 and 24 extend toward each other in the opening 20. The buffer elements 22 and 24 limit a movement of the receiving openings 16 and 18 toward each other. The buffer elements 22 and 24 extend along and parallel to the line G.

The spring section 14 is composed of four bending beams 26, 28, 30, 32. The bending beams 26, 28 and 30, 32 form respective bending beam pairs. Each of the bending beam pairs extends starting from a transition region or connecting region 34 and 36, between the receiving openings 16 and 18 and the spring section 14. The bending beams 26 and 32 and the bending beams 28 and 30 are respectively connected to each other by means of a bent section 38 and 40. In the region of the bent sections 38 and 40, the inner wall 42 of the opening 20 is embodied as fluted. The bending beams 26, 28, 30, 32 each taper in the direction of the bent sections 38 and 40.

On their inner circumference, the receiving openings 16 and 18 are provided with grooves 44 distributed over their inner circumference, which should make it easier for the receiving openings 16 and 18 to receive the fastening elements.

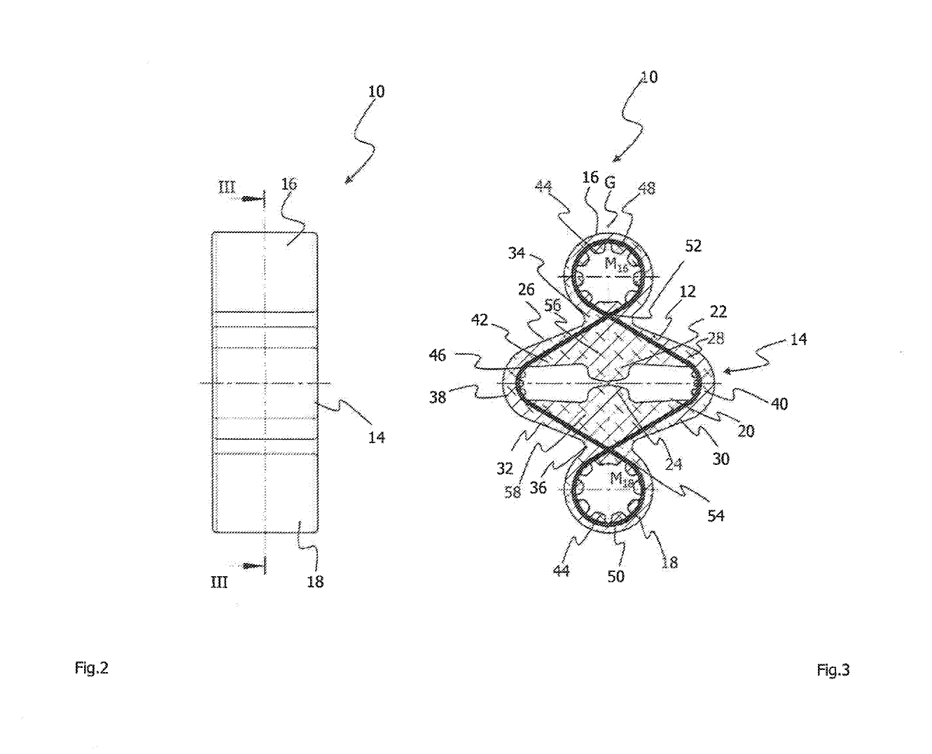

FIG. 2 is a side view of the elastic support 10, showing the elastomer body 12 with the spring section 14 and the receiving openings 16 and 18.

FIG. 3 shows a sectional view along the section line in FIG. 2.

The elastomer body 12 has the spring section 14 and the receiving openings 16 and 18. The receiving openings 16 and 18 are positioned outside of the spring section 14. The spring section 14 includes a textile reinforcement 46. The receiving openings 16 and 18 are each also associated with a textile reinforcement 48 and 50. The receiving openings 16 and 18 are each completely surrounded by their respective textile reinforcement 48 and 50. The textile reinforcement 46 of the spring section 14 is connected to the textile reinforcements 48 and 50 of the receiving openings 16 and 18 at the transition points and the connecting points 52 and 54. The textile reinforcements 46, 48, and 50 can be sewn to each other or woven with each other at the transition points 52 and 54. It is likewise possible for the textile reinforcements 46, 48, and 50 to be embodied of one piece. In this case, the strand respectively used for the textile reinforcements 46, 48, and 50 is routed crosswise at the transition points 52 and 54.

Between the transition points 52 and 54, the textile reinforcement 46 of the spring section 14 extends along the bending beams 26, 28, 30, 32 and the bent sections 38 and 40. The textile reinforcement 46 extends essentially in rhomboid fashion in the spring section 14, with the transition points 52 and 54 forming two corner points of the rhomboid and the bent sections 38 and 40 forming two other corner regions of the rhomboid. The receiving openings 16 and 18 are positioned outside of the textile reinforcement 46 of the spring section 14. The textile reinforcement 46 encompasses the opening 20 in the spring section 14.

In the region of the bent sections 38 and 40, the textile reinforcement 46 of the spring section 14 extends close to the inner wall 42 of the opening 20 so that in this region, the textile reinforcement 46 is covered by only a thin, fluted layer of the elastomer of the elastomer body 12. The same is true for the receiving openings 16 and 18 in the region of the grooves 44. Also in the region of the grooves 44, the textile reinforcement 48 and 50 of the receiving openings is covered by only a thin, fluted layer of the elastomer. In alternative embodiments, the elastomer layer can also be embodied with a greater material thickness.

In the loaded state of the elastic support 10, it is placed under tensile stress, causing the receiving openings 16 and 18 to move away from each other while the two bent sections 38 and 40 of the spring section 14 move toward each other, particularly in a direction perpendicular to the line G. This approaching movement causes a compression of the elastomer of the elastomer body 12, in particular the sections 56 and 58 enclosed between the textile reinforcement 46 and the opening 20. These regions 56 and 58 are subjected to compressive and/or shearing force by the textile reinforcement 46 when—in the loaded state of the elastic support 10—the receiving openings 16 and 18 move away from each other and the bent sections 38 and 40 move toward each other.

Other embodiments of the invention are described below. For similar or similarly acting features, the same reference numerals are used as in the first embodiment described above.

FIG. 4 shows a perspective view of an elastic support 110 according to a second embodiment of the invention.

The elastic support 110 has an elastomer body 12. The elastomer body 12 includes two spring sections 14₁ and 14₂ and two receiving openings 16 and 18. The spring sections 14₁ and 14₂ are positioned between the two receiving openings 16 and 18. The spring sections 14₁ and 14₂ are connected to each other by means of a connecting region 60.

The spring sections 14₁ and 14₂ are embodied identically to the spring section 14 described in detail above with reference to FIGS. 1 to 3. Each of the spring sections 14₁ and 14₂ is composed of four bending beams 26, 28, 30, 32. The bending beams 26, 28 and 30, 32 form respective bending beam pairs. The bending beam pair 30, 32 of the spring section 14₁ is connected to the bending beam pair 26, 28 of the spring section 14₂ by means of the connecting region 60. The bending beams 26 and 32 and the bending beams 28 and 30 of the spring sections 14₁ and 14₂ are respectively connected to each other by means of bent sections 38 and 40.

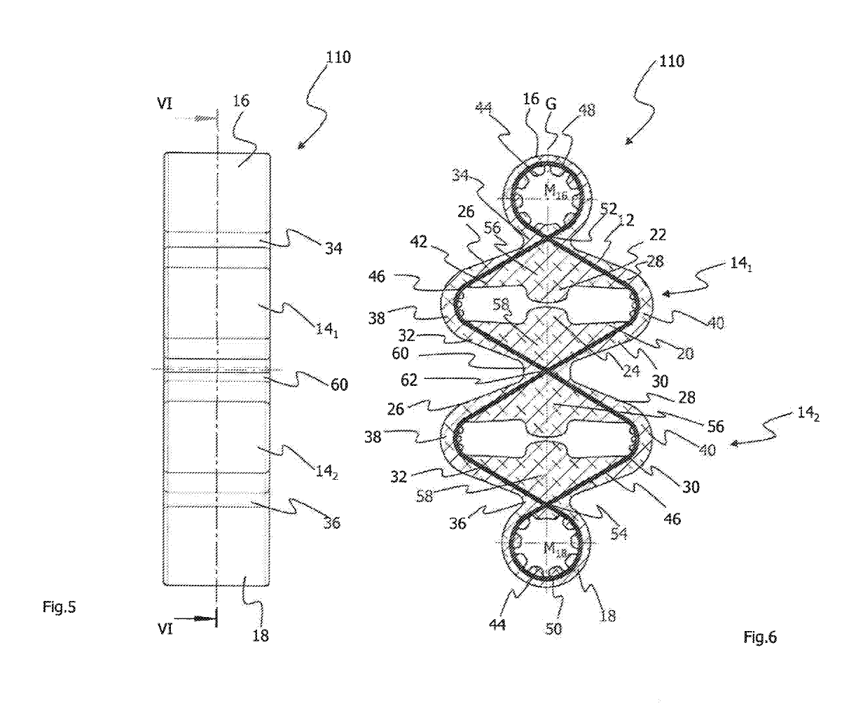

FIG. 5 is a side view of the elastic support 110 showing the elastomer body 12 with its receiving openings 16, 18, the spring sections, 14₁ and 14₂, and the connecting section 60 between the two spring sections 14₁ and 14₂.

FIG. 6 shows a sectional view along the section line VI-VI in FIG. 5.

The spring sections 14₁ and 14₂ each have a textile reinforcement 46. The textile reinforcements 46 of the spring sections 14₁ and 14₂ are connected to each other at the transition point 62 in the connecting region 60 or transition into each other at the transition point 62. The textile reinforcements 46 extend essentially in rhomboid fashion in the elastomer body 12. The textile reinforcement 46 of the spring section 14₁ is connected to the textile reinforcement 48 of the receiving openings 16 at the transition point 52. The textile reinforcement 46 of the spring section 14₂ is connected to the textile reinforcement 50 of the receiving opening 18 in the same way. There are thus three transition points 52, 54, and 60 provided at which the textile reinforcement 50 of the receiving opening 16 transitions into the textile reinforcement 46 of the spring section 14₁, the textile reinforcement 46 of the spring section 14₁ transitions into the textile reinforcement 46 of the spring section 14₂, and the textile reinforcement 46 of the spring section 14₂ transitions into the textile reinforcement 50 of the receiving opening 18.

In the loaded state of the elastic support 110, i.e. when the elastic support 110 is being stretched, regions of the elastomer of the elastomer body 12, particularly those that are enclosed between the textile reinforcements 46 and the openings 20 of the spring sections 14₁ and 14₂, are compressed and thus subjected to compressive and/or shearing force.

The center axes M₁₆ and M₁₈ of the receiving openings 16 and 18 are positioned on a line G. The receiving openings 16 and 18 are positioned along the line G, outside of the spring sections 14₁ and 14₂. The elastic support 110 is also embodied in an axially symmetrical fashion so that the line G corresponds to the symmetry axis of the elastic support 110.

FIG. 7 shows a perspective view of an elastic support 210 according to a third embodiment of the invention.

The elastic support 210 has an elastomer body 12. The elastomer body 12 includes two spring sections 14₁ and 14₂ and three receiving openings 16, 18, and 64. The spring section 14₁ is positioned between the receiving opening 16 and the receiving opening 64. The spring section 14₂ is positioned between the two receiving openings 64 and 18. The receiving openings 64 are correspondingly positioned between the two spring sections 14₁ and 14₂. The spring sections 14₁ and 14₂ are embodied essentially identically to the spring sections, 14 according to the two above-described embodiments. The receiving opening 64 constitutes the center of the elastomer body 12. The receiving opening 64 is connected to each other to the spring section 14₁ by means of a connecting region 66 and to the spring section 14₂.

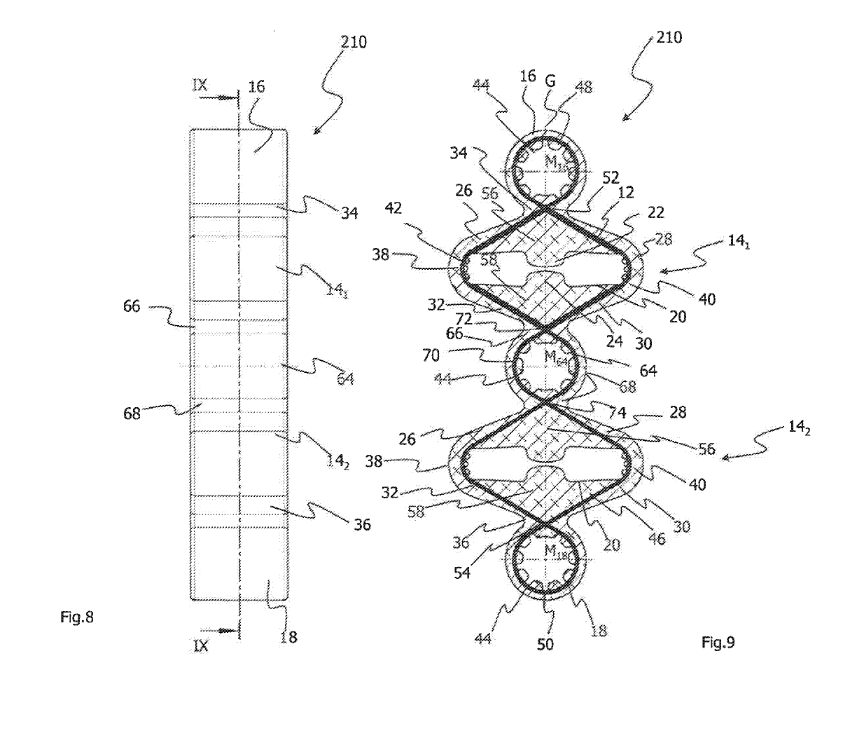

FIG. 8 is a side view of the elastic support 210, showing the elastomer body 12. The elastomer body 12 includes the receiving openings 16, 18, the spring sections 14₁ and 14₂, and the receiving opening 64 positioned between the two spring sections 14₁ and 14₂. The receiving openings 16 and 18 are connected to the spring sections 14₁ and 14₂ by means of the transition regions 34 and 36. The spring sections 14₁ and 14₂ are connected to the receiving opening 64 by means of connecting regions or transition regions 66 and 68.

FIG. 9 shows a sectional view along the section line IX-IX in FIG. 8.

The receiving opening 64 is positioned between the two spring sections 14₁ and 14₂. The spring section 14₁ is thus positioned between the receiving opening 16 and the receiving opening 64. The spring section 14₂ is positioned between the receiving opening 64 and the receiving opening 18.

Like the receiving openings 16 and 18, the receiving opening 64 is associated with a textile reinforcement 70. The textile reinforcement 70 completely surrounds the receiving opening 64. The textile reinforcement 70 is connected to the textile reinforcements 46 of the two spring sections 14₁ and 14₂ at the transition points 72 and 74.

The center axes M₁₆, M₁₈ and M₆₄ of the receiving openings 16, 18, and 64 lie on a line G. The receiving openings 16, 18, and 64 are positioned along the line G, outside of the spring sections 14₁ and 14₂. The elastic support 210 is embodied as axially symmetrical so that the line G corresponds to the symmetry axis of the elastic support 210.

FIG. 10 shows a perspective view of an elastic support 310 according to a fourth embodiment of the invention.

The elastic support 310 has an elastomer body 12. According to this embodiment, the elastomer body 12 is embodied as angled. The elastomer body 12 has two spring sections 14₁ and 14₂ between which is positioned a receiving opening 64. Starting from this receiving opening 64, the two spring sections 14₁ and 14₂ extend at a predetermined angle in the direction of the receiving openings 16 and 18. The spring sections 14₁ and 14₂ are positioned between the receiving openings 16, 18, and 64. The openings 20 in the elastomer body 12 and in the spring sections, 14₁ and 14₂ are embodied as essentially rectangular. The spring section 14₂ is embodied as less expansive and is thus smaller than the spring section 14₁.

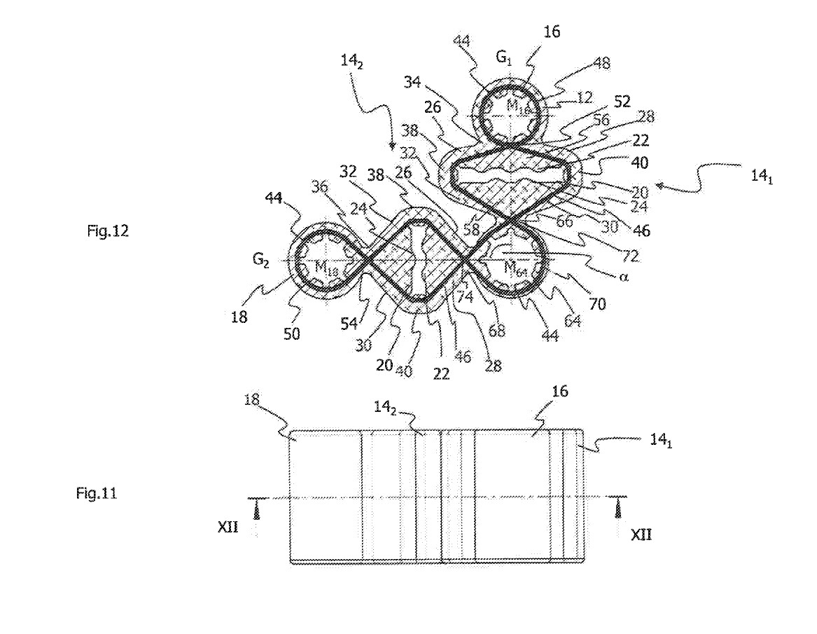

FIG. 11 is a side view of the elastic support 310, showing the elastomer body 12 with its receiving openings 16, 18 and the spring sections 14₁ and 14₂.

FIG. 12 shows a sectional view along the section line XII-XII in FIG. 11.

The center axes M₁₆ and M₆₄ of the receiving openings 16 and 64 lie on a line G₁. The center axes M₁₈ and M₆₄ of the receiving openings 18 and 64 lie on a line G₂. The intersecting point of the lines G₁ and G₂ lies on the center axis M₆₄ of the receiving opening 64. The center axes M₁₆ and M₁₈ of the receiving openings 16 and 18 are positioned offset from each other by a predetermined angle α around the center axis M₆₄ of the receiving opening 64. According to the embodiment shown in FIG. 12, the angle α can be approximately 90°. In other words, the lines G₁ and G₂, which intersect at the center axis M₆₄ of the receiving opening 64, enclose a predetermined angle α with each other.

In a direction transverse to the line G₂, the spring section 14₂ is embodied as smaller or narrower than the spring section 14₁ in a direction transverse to the line G₁. The opening 20 of the spring section 14₁ has a larger dimension in a direction transverse to the line G₁ than the opening 20 of the spring section 14₂ has in a direction transverse to the line G₂ auf. The openings 20 of the spring sections 14₁ and 14₂ are embodied as essentially rectangular. The openings 20 have respective buffer formations 22 and 24, which are oriented toward each other in order to be able to limit movements of the receiving openings 16 and 64 and the receiving openings 18 and 64 toward one another. The buffer formations 22 and 24 in this case are embodied so that each buffer of the buffer formation 24 is oriented toward a respective region between two buffers of the buffer formations 22.

The receiving openings 16, 18, and 64 are completely surrounded by their textile reinforcements 48, 50 and 70. The textile reinforcement 48 is connected to the textile reinforcement 46 of the spring section 14₁ at the transition point or connecting point 52. The textile reinforcement 50 is connected to the textile reinforcement 46 of the spring section 14₂ at the transition point or connecting point 54. The textile reinforcements 46 of the spring sections 14₁ and 14₂ are connected to the textile reinforcement 70 of the receiving opening 64 at the transition points or connecting points 72 and 74. The transition points 72 and 74 lie in the transition regions or connecting regions 66 and 68, which are offset from each other by the predetermined angle α and lie on the lines G₁ and G₂.

The elastic support 310 can constitute a fixed support and based on its angled design, can absorb forces from three spatial directions.

1. An elastic support for a load, with
at least one elastomer body; the at least one elastomer body has at least one spring section and at least two receiving openings for receiving fastening elements; the spring section has at least one reinforcement; at least one of the two receiving openings is positioned outside of the reinforcement of the at least one spring section; and at least one of the two receiving openings is associated with at least one reinforcement that surrounds the respective receiving opening and is connected to the reinforcement of the spring section,
wherein the reinforcement of the at least one spring section and the reinforcement of the at least one receiving opening is a textile reinforcement.

2. The elastic support according to claim 1,
wherein the at least two receiving openings are positioned outside of the reinforcement of the at least one spring section and each of the at least two receiving openings is associated with at least one reinforcement that surrounds the respective receiving opening and is connected to the reinforcement of the spring section.

3. The elastic support according to claim 1,
wherein the at least one spring section is positioned between the at least two receiving openings.

4. The elastic support according to claim 1,
wherein the spring section is composed of bending beams and the reinforcement of the spring section extends along the bending beams.

5. The elastic support according to claim 1,
wherein the reinforcements associated with the at least two receiving openings are connected to the reinforcement of the at least one spring section at two opposing transition points.

6. The elastic support according to claim 5,
wherein each bending beam pair extends starting from one of the transition points and the bending beams of the bending beam pairs are connected to each other by means of a bent section.

7. The elastic support according to claim 5,
wherein the reinforcement of the spring section extends between the transition points, along the bending beams and the bent sections.

8. The elastic support according to claim 1,
wherein the spring section has at least one opening.

9. The elastic support according to claim 8,
wherein the opening is positioned between the bending beams and the bent sections of the spring section in the elastomer body.

10. The elastic support according to claim 8,
wherein the opening has at least one buffer element.

11. The elastic support according to claim 1,
wherein the elastomer body has two spring sections between the at least two receiving openings.

12. The elastic support according to claim 11,
wherein an additional receiving opening is embodied between the two spring sections.

13. The elastic support according to claim 12,
wherein the additional receiving opening is associated with a reinforcement that is connected to the reinforcements of the two spring sections.

14. The elastic support according to claim 13,
wherein the remaining receiving openings are positioned so that they are offset by a predetermined angle around the center axis of the receiving opening between the spring sections.

15. The elastic support according to claim 1,
wherein the reinforcement of the at least one spring section and the reinforcement of the at least one receiving opening are sewn to each other or woven with each other.

16. The elastic support according to claim 1,
wherein the reinforcement of the at least one spring section and the reinforcement of the at least one receiving opening are produced in one piece out of a single strand and the strand is routed crosswise at the transition points between the at least one spring section and the at least one receiving opening.

17. An exhaust system for a vehicle equipped with an elastic support according to claim 1.

18. A vehicle equipped with an exhaust system according to claim 17.

19. The elastic support according to claim 2,
wherein the elastomer body has two spring sections between the at least two receiving openings.

20. The elastic support according to claim 3,
wherein the elastomer body has two spring sections between the at least two receiving openings.
